(19) United States
(12) Patent Application Publication
(10) Pub. No.: US 2010/0186884 A1
(43) Pub. Date: Jul. 29, 2010

(54) THERMAL TRANSFER SHEET MANUFACTURING METHOD, THERMAL SHEET, AND THERMAL TRANSFER METHOD

(76) Inventor: Tetsuya Matsuyama, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 11/916,133

(22) PCT Filed: Jun. 2, 2006
(86) PCT No.: PCT/JP2006/311090

§ 371 Date: Feb. 19, 2008

(30) Foreign Application Priority Data
Jun. 3, 2005 (JP) 2005-164732

(51) Int. Cl. B44C 1/165; B41M 3/12

(52) U.S. Cl. 156/230; 427/146

(57) ABSTRACT

It is possible to provide a thermal transfer sheet capable of obtaining a hairline pattern easily and quickly.

A thermal transfer sheet 1 is manufactured by the following method. The thermal transfer sheet has a transfer layer 12 layered on a substance sheet 10. A predetermined pattern is formed on the surface of the transfer layer 12. The predetermined pattern of the transfer layer 12 is formed by copying plenty of grooves 12a . . . 12a from a master plate 30, the plenty of grooves 12a . . . 12a being formed in a hairline pattern on a surface of the master plate 30.

### TECHNICAL FIELD

The present invention relates to a thermal transfer sheet manufacturing method and a thermal transfer method.

### BACKGROUND ART

The method of transferring an optical diffraction structure to a transferred body by using a thermal transfer sheet having a transfer layer where the optical diffraction structure of concavo-convex patterns is formed is well known (see a patent document 1 and a patent document 2, for example).

Patent document 1: S63-137287-JP-A

Patent document 2: H01-283583-JP-A

### DISCLOSURE OF THE INVENTION

### Problems to be Solved by the Invention

However, in a case where a concavo-convex pattern is big enough not to generate diffraction, the concavo-convex pattern is usually formed by machine cutting. Therefore, the case involves an immense amount of time and effort. Moreover, especially, in a chase of a form constituted by fine lines such as a hairline pattern and formed incidentally, it is difficult to form completely same forms by the machine cutting.

Consequently, it is an object of the present invention to provide a thermal transfer sheet and a thermal transfer method capable of obtaining hairline pattern easily and quickly.

### Means for Solving the Problems

A thermal transfer sheet manufacturing method of the present invention solves the above problems by the following: a thermal transfer sheet manufacturing method, the thermal transfer sheet having a transfer layer layered on a substance sheet, a predetermined pattern being formed on a surface of the transfer layer, wherein the predetermined pattern of the transfer layer is formed by copying plenty of grooves from a master plate, the plenty of grooves being formed in a hairline pattern on a surface of the master plate.

By the thermal transfer sheet manufactured by this method, patterns in a shape of hairline can be printed by a thermal transfer printer. Moreover, as the patterns in the shape of hairline formed on the transfer layer to be transferred are formed with plenty of grooves, the patterns have stereoscopic concavo-convex. Therefore, the hairline patterns similar to the hairline patterns obtained by machine cutting can be obtained easily and quickly.

Moreover, in a chase of machine cutting, because of eventuality it is difficult to obtain the same patterns repeatedly. However, if the thermal transfer sheet manufactured by the present invention is used and the pattern same as the master plate to be used at manufacturing is copied repeatedly, the pattern same as the master plate can be printed repeatedly.

The surface of the transfer layer where the plenty of grooves are copied may be metal evaporated. By the thermal transfer ribbon obtained by this manufacturing method, as the surface of grooves of the hairline patterns on the transfer layer is metal evaporated, the surface of grooves looks like almost a real hairline process in a shape and a texture. Thereby, almost same visual quality can be obtained. Additionally, because of the almost same visual quality, more expensive-looking can be represented. Further, the present invention can be realized as a thermal transfer sheet manufactured by the above two methods.

The thermal transfer method of the present invention solves above problems by the following: a thermal transfer method of, while sending in a predetermined direction a thermal transfer sheet where a transfer layer is layered on a substance sheet, transferring the transfer layer from the thermal transfer sheet to a transferred body, the transfer layer having plenty grooves formed in the shape of hairline so that the grooves flow unidirectionaly, wherein a flowing direction of the plenty of grooves of the transfer layer is coincided with a sending direction of the thermal transfer sheet. A thermal transfer method of, while sending in a predetermined direction a thermal transfer sheet where a transfer layer is layered on a substance sheet, transferring the transfer layer from the thermal transfer sheet to a transferred body, the transfer layer having plenty of grooves formed in a hairline pattern so that the grooves look like flowing unidirectionaly, wherein a flowing direction of the plenty of grooves of the transfer layer is coincided with a sending direction of the thermal transfer sheet. A thermal source may be whichever a heat generation element of a thermal head or a laser light.

When printing with a thermal transfer printer, the thermal transfer sheet having the transfer layer where fine concavo-convex patterns are formed, at the moment of transferring, fine spiral shapes appear at random on the transferred patterns. The fine spiral shapes cause mottled appearance which represents rainbow color depending on a view angle. The inventor has found out that in a case where the fine concavo-convex pattern is the hairline pattern, this phenomenon is related to a printing direction and a flowing direction of grooves forming the hairline pattern, and when the both directions are the same, the phenomenon is hard to appear. Therefore, by the thermal transfer method of the present invention, it is possible to stem the mottled appearance, and print the hairline pattern with a constant quality.

### Effects of the Invention

As mentioned above, according to the present invention, the pattern of the transfer layer is formed by copying plenty of grooves from a master plate, the plenty of grooves being formed in a hairline pattern on a surface of the master plate. Thereby, a thermal transfer sheet and a thermal transfer method by which it is possible to obtain the hairline pattern easily and quickly.

### BRIEF DESCRIPTION OF DRAWINGS

FIG. 1 A diagram showing one example of a thermal transfer sheet employed to the present invention.

FIG. 2 A diagram showing one example of hairline pattern formed on a transfer layer of the thermal transfer sheet shown in FIG. 1.

FIG. 3 A diagram showing steps of manufacturing the thermal transfer sheet shown in FIG. 1.

FIG. 4A A sectional view showing a state that the thermal transfer sheet shown in FIG. 1 is transferred to a transferred body.

FIG. 4B A diagram showing a state that the thermal transfer sheet shown in FIG. 1 is heated.

FIG. 5 A diagram showing one example of a print result by using the thermal transfer sheet shown in FIG. 1.

### BEST MODE FOR CARRYING OUT THE INVENTION

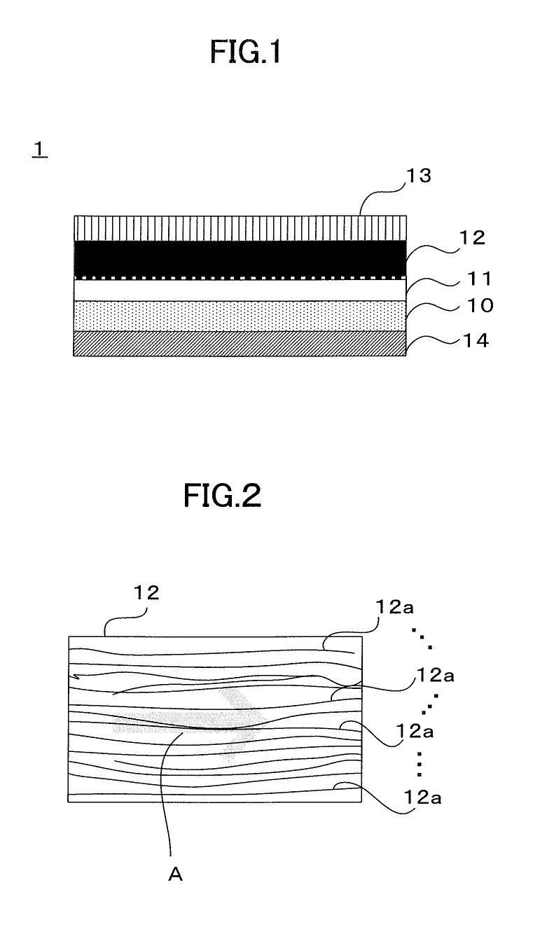

FIG. 1 shows one example of a thermal transfer sheet 1 of the present invention. In the thermal transfer sheet 1, a peeling layer 11, a transfer layer 12, and an adhesion layer 13 are layered on a substance sheet 10. On the other side of the substance sheet 10, a back side layer 14 is layered. The peeling layer 11 is layered to enhance a property of peeling the transfer layer 12 from the substance layer 10. The adhesion layer 13 is layered to enhance a property of adhering with a transferred body. The back side layer 14 is layered to prevent a thermal head from adhering and move the thermal head smoothly.

It is enough that each of the substance layer 10, the peeling layer 11, the adhesion layer 13 or the back side layer 14 is a layer to be used for a conventional thermal transfer sheet (hereinafter, the thermal transfer sheet is referred to as “a hologram transfer sheet”) having a transfer layer where a convex-concavo pattern of optical diffraction structure is formed. The transfer layer 12 is constituted by a ultra-violet cured resin. On the ultra-violet cured resin, plenty of grooves 12a . . . 12a in the shape of hairline as shown in FIG. 2 are formed, and aluminum evaporation is provided to the surface of the transfer layer 12. Each of the grooves 12a is formed as looking like flowing in the same direction A.

The method of manufacturing the thermal transfer sheet 1 will be described. First, in the first step, for a surface of predetermined metal board 20, a hairline process is executed by cutting and the like. That is, plenty of grooves 20a in the shape of hairline (hereinafter, which are sometimes referred to as “a hairline pattern 20a”) are formed on the surface of the metal board 20. A conventional method can be applied to a method of this process. However, it is prefer that the depth of each groove 20a is not more than the thickness of an ultra-violet cured resin layer 12′, mentioned later. Every step mentioned later can be executed by a similar method to a method used at the moment of manufacturing a hologram transfer sheet except for using the metal board 20 where the hairline pattern is formed.

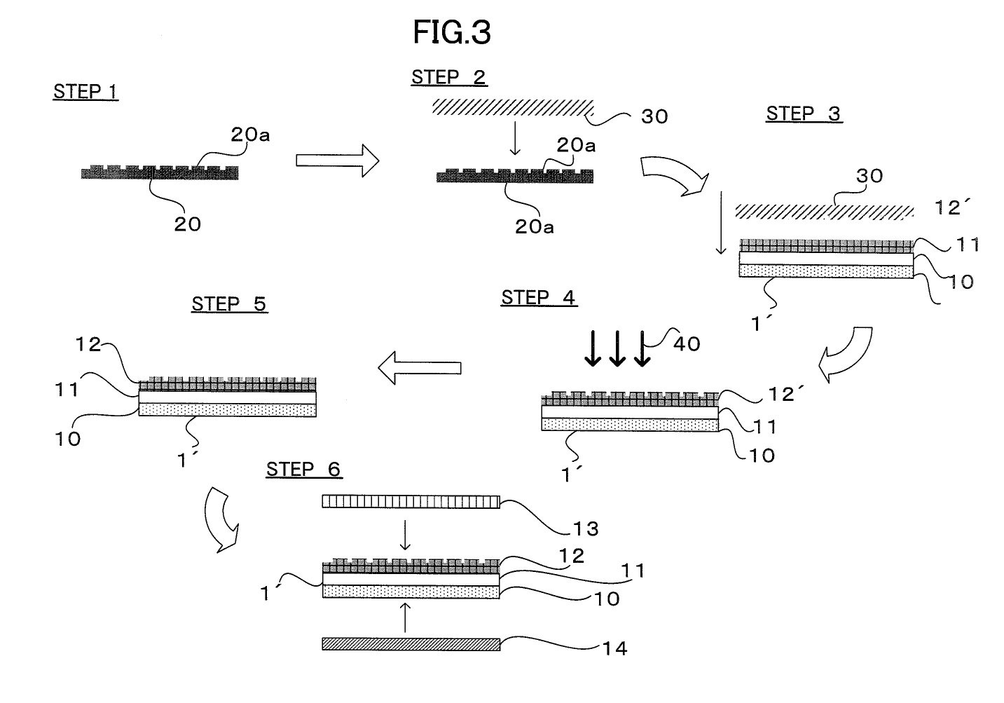

In the second step, a copy master plate 30 is manufactured by copying the hairline pattern 20a by the 2P method from the metal board 20 which has been hairline-processed. In the third step, the hairline pattern 20a of the copy master plate 30 is transferred to a surface of an ultra-violet cured resin layer 12′ constituted by an ultra-violet cured resin. The ultra-violet cured resin is included in a lamination body 1′ where the peeling layer 11 and the ultra-violet cured resin layer 12′ are layered on the substance sheet 10. Each layer in the lamination body 1′ corresponds to the substance sheet 10, the peeling layer 11, and the transfer layer 12 respectively. The lamination body 1′ shown in FIG. 3 looks short, but actually the lamination body 1′ is long and sheet-shaped.

Accordingly, when the copy master plate 30 is wrapped around a plate cylinder and sent out at a predetermined speed so that the side of the ultra-violet cured resin layer 12′ of the lamination body 1′ is pressed to the surface of the copy master plate 30 on the plate cylinder, the hairline pattern of the copy master plate 30 is repeatedly transferred on the ultra-violet cured resin 12′. It does not matter which one of the transfer methods of transferring emboss-patterns wrapped around the plate cylinder is applied to this invention.

In the fourth step, the ultra-violet cured resin layer 12′ gets hardened to get fix the hairline pattern by irradiating the ultra-violet light 40 to the ultra-violet cured resin layer 12′ where the hairline pattern has been transferred. Next, in the fifth step, the surface of the fixed hairline pattern is aluminum-evaporated. Finally, in the sixth step, the thermal transfer sheet 1 is manufactured by layering the adhesion layer 13 on the transfer layer 12 that is the ultra-violet cured resin layer 12′which has been aluminum-evaporated, and layering the back side layer 14 on the opposite side of the substance sheet 10.

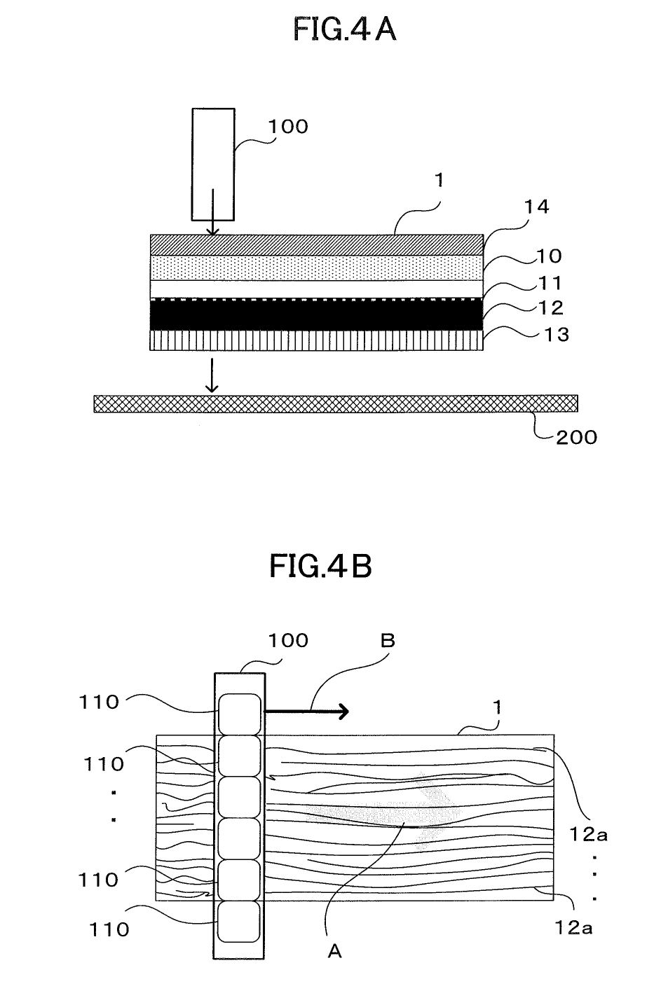

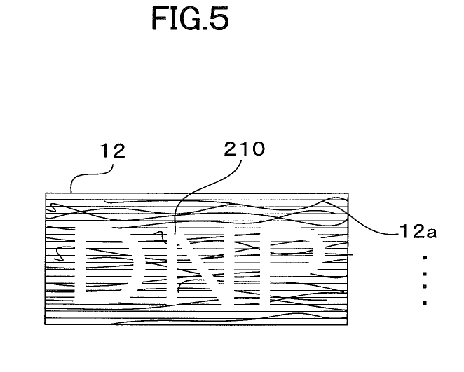

Next, it will be explained by using FIG. 4A and FIG. 4B about the method of printing with a thermal transfer printer, the hairline pattern of the thermal transfer sheet 1 on a transferred body 200. The back side layer 14 of the thermal transfer sheet 1 is pressed to the transferred body 200 by a thermal head 100 of the thermal transfer printer. Because of that, the thermal transfer sheet 1 is heated from the side of the back side layer 14 by plural heat generation elements 110 . . . 110 constituting the thermal head 100. By the heating, the transfer layer 12 is peeled from the peeling layer 11 to transfer the transfer layer 12 where the hairline pattern is formed and the adhesion layer 13 on the transferred body 200. Thereby, the hairline pattern is printed on the transferred body 200.

By sending the thermal transfer sheet 1 in the direction B, a heat position of the heat generation elements 110 moves in the direction B (hereinafter, the direction B is referred to as “the heat direction B”.) Accordingly, the thermal transfer sheet 1 is heated sequentially in the heat direction B and the transfer layer 12 is transferred sequentially in the heat direction B. The moving of the heat position should be set so that the heat direction B coincides with the flowing direction A of the grooves 12a formed in the hairline pattern on the transfer layer 12 of the thermal transfer sheet 1.

It is possible to print the hairline pattern 12a to form a desired shape by moving the heat position. For example, as shown in FIG. 5, the hairline pattern 12a can be printed in a state where the letters 210 of “DNP” are outlined by the hairline pattern 12a.

The present invention is not limited to the above mentioned embodiment, and various embodiments can be applied to the present invention. For example, the copy master plate is not limited to be a metal plate. For example, to make the copy master plate 30, grooves in the shape of hairline can be formed by irradiating a laser light to a thermoplastic material such as wax. In the above embodiment, the aluminum evaporation is executed after transferring the emboss pattern, but, the emboss pattern can be transferred to the thermal plastic resin where a metal reflection layer is layered in advance. If the thermal transfer sheet 1 has enough property of peeling, and enough property of smoothing, it is not necessary to layer the peeling layer 11 and the back side layer 14. On the contrary, another layer can be added to the thermal transfer sheet in accordance with the aim of usage, a usage circumstances and the like. Moreover, the method of heating at the moment of printing is not limited to the method with the thermal head 100, and the method using heat caused by a laser light can be applied.

1. A thermal transfer sheet manufacturing method, the thermal transfer sheet having a transfer layer layered on a substance sheet, a predetermined pattern being formed on a surface of the transfer layer, wherein
the predetermined pattern of the transfer layer is formed by copying plenty of grooves from a master plate, the plenty of grooves being formed in a hairline pattern on a surface of the master plate.

2. The thermal transfer sheet manufacturing method according to claim 1, wherein the surface of the transfer layer where the plenty of grooves are copied is metal evaporated.

3. A thermal transfer sheet manufactured by the thermal transfer sheet manufacturing method according to claim 1.

4. A thermal transfer method of, while sending in a predetermined direction a thermal transfer sheet where a transfer layer is layered on a substance sheet, transferring the transfer layer from the thermal transfer sheet to a transferred body, the transfer layer having plenty of grooves formed in a hairline pattern so that the grooves look like flowing unidirectionaly, wherein
a flowing direction of the plenty of grooves of the transfer layer is coincided with a sending direction of the thermal transfer sheet.

5. The thermal transfer method according to claim 4, wherein a thermal source is a heat generation element of a thermal head.

6. The thermal transfer method according to claim 4, wherein a thermal source is a laser light.
